(19) United States
(12) Patent Application Publication
(10) Pub. No.: US 2026/0135354 A1
(43) Pub. Date: May 14, 2026

(54) HEAD OF GROUP ARRANGEMENTS IN RELAY BASED ELECTRICAL PANELS

(71) Applicant: Schneider Electric USA, Inc., Andover, MA (US)

(72) Inventor: Chad R. Mittelstadt, Cedar Rapids, IA (US)

(73) Assignee: Schneider Electric USA, Inc., Boston, MA (US)

(21) Appl. No.: 18/947,797

(22) Filed: Nov. 14, 2024

(51) Int. Cl. H02B 1/04

(52) U.S. Cl. CPC H02B 1/04

(57) ABSTRACT

A system includes an electrical panel having an interior including a line-in with a main isolator electrically connecting between the line-in and a main line bus. A plurality of head of group (HOG) components can be electrically connected to the main line bus. Each HOG component includes a solid state switching component(s) electrically connecting between the main line bus and a line sub bus of the HOG component, a plurality of circuit connectors electrically connected to the line sub bus of the HOG component, and a plurality of branch devices, e.g. controllable electromechanical relay devices, electrically respectively connected to at least some of the circuit connectors.

### BACKGROUND

### 1. Field

The present disclosure relates to electrical panels, and more particularly to panels such as for residential buildings.

### 2. Description of Related Art

Electrical panels for residential buildings typically have main switches that disconnect the panel busses from the lines coming into the panel from the utility meter. The main switch disconnects all of the circuits of the panel. Each circuit in the panel has its own dedicated breaker, often referred to as miniature circuit breakers (MCBs). There is an opportunity to replace more traditional MCBs with solid state-based breakers for advanced circuit protection, diagnostics, and control. Solid state devices offer control benefits that integrate well into automation systems and the like, however they have limitations today in amperage and size for the amperage of the main switch, e.g. 200 A in a typical panel.

The conventional techniques have been considered satisfactory for their intended purpose. However, there is an ever-present need for improved systems and methods for solid state based electrical panels. This disclosure provides a solution for this need.

### SUMMARY

A system includes an electrical panel having an interior including a line-in with a main isolator electrically connecting between the line-in and a main line bus. A head of group (HOG) component is electrically connected to the main line bus. The HOG component includes a solid state switching component electrically connecting between the main line bus and a line sub bus of the HOG component, a plurality of circuit connectors electrically connected to the line sub bus of the HOG component, and a plurality of branch devices electrically respectively connected to at least some of the circuit connectors.

The panel can include a second line-in with a second main isolator electrically connecting between the second line-in and a second main line bus. The HOG component can be electrically connected to the second main line bus. The HOG component can include a second solid state switching component electrically connecting between the second main line bus and a second line sub bus of the HOG component, and a second plurality of circuit connectors electrically connected to the second line sub bus of the first HOG. The plurality of branch devices can be respectively electrically connected to at least some of the second plurality of circuit connectors.

The panel can include a neutral main bus. The HOG component can include a neutral line sub bus electrically connected to the neutral main bus and a third plurality of circuit connectors electrically connected to the neutral line sub bus. The plurality of branch devices can be respectively electrically connected to at least some of the third plurality of circuit connectors.

The interior can include a main data bus with controller operatively connected to the main data bus. The HOG component can include a data sub bus. The data sub bus can be operatively connected to the main data bus and can include a feedback sensor. The controller can be configured to: monitor feedback signals from the feedback sensor and/or from the plurality of branch devices, command the solid state switching component to open upon the receiving a signal through the main data bus and/or the data sub bus indicative of a fault in the line sub bus, determine which of the plurality of branch devices is connected to the fault, command any of the plurality of branch devices connected to the fault to open, and command the solid state switching component to close, allowing the plurality of branch devices other than any of the plurality of branch devices connected to the fault to resume service supplying power to their respective circuits.

The controller can be in the interior and can operatively connect to the HOG component through the main data bus. The controller can be in the HOG component and can operatively connect to the main data bus and to the data sub bus.

The HOG component can be one in a plurality of HOG components, each electrically connected to the main line bus. Each HOG component can include respectively: a solid state switching component electrically connecting between the main line bus and a line sub bus of the HOG component, a plurality of circuit connectors electrically connected to the line sub bus of the HOG component, and a plurality of branch devices electrically respectively connected to at least some of the circuit connectors. Each respective HOG component in the plurality of HOG components can include a respective controller in the respective HOG component operatively connected to the main data bus.

Each branch device in the plurality of branch devices can include a respective electromechanical relay electrically connected between the line sub bus and an output connector for selectively supplying power to a respective circuit or suspending supply of power to the respective circuit depending on state of the electromechanical relay. The system can include one or more controllers operatively connected to control state of each respective electromechanical relay.

The interior can include an electrically insulative enclosure around the main isolator and main line bus, with a respective contact opening therethrough for electrical contact between the main line bus and each of one or more respective HOG components. The main isolator can include a mechanism for both manual operation and automatic operation by a controller.

A head of group (HOG) component can include a HOG housing that is electrically insulative. A solid state switching component can be included in the HOG housing. At least one opening through the HOG housing can provide for electrical connection of a main line bus external of the housing, through the housing, and to the solid state switching component. A line sub bus can be included in the HOG housing. The solid state switching component can be configured to electrically connect between the main line bus and the line sub bus. A plurality of circuit connectors can be electrically connected to the line sub bus of the HOG component for electrical connection of a plurality of branch devices to the line sub bus.

The HOG component can include a second solid state switching component in the HOG housing. At least one opening through the HOG housing can provide for connection of a second main line bus external of the housing, through the housing, and to the solid state switching component. A second line sub bus can be included in the HOG housing. The second solid state switching component can be configured to electrically connect between to the second main line bus the second line sub bus. A second plurality of circuit connectors can be electrically connected to the second line sub bus for electrical connection of a plurality of branch devices to the second line sub bus.

A neutral line sub bus can be included in the HOG housing, configured to be electrically connected to an external neutral main bus. A third plurality of circuit connectors can be electrically connected to the neutral line sub bus, for electrical connection of at least some of the plurality of branch devices to the neutral line sub bus. The HOG housing can include a main switching module, and a connector module extending along a longitudinal direction from the switching module along a longitudinal axis.

The first line sub bus, second line sub bus, and neutral line sub bus can all extend from the main switching module and inside the connector module in the longitudinal direction. The first plurality of connector openings can include: one or more first openings that open on a first side of the connector module lateral to the longitudinal direction at a first elevation, one or more second openings at the first elevation on a second side of the connector module, and one or more third openings on the first side of the connector module at a second elevation off set from the first elevation. The first line sub bus can include a first portion at the first elevation that is adjacent the first and second openings, and a second portion that is at the second elevation along only the first side of the connector module at the second elevation adjacent to the third openings.

The second plurality of connector openings can include: one or more fourth openings that open on the first side of the connector module lateral to the longitudinal direction at the second elevation, one or more fifth openings at the second elevation on the second side of the connector module adjacent to the second openings, and one or more sixth openings at the second elevation on the second side of the connector module offset from the second openings. The second line sub bus can include a first portion at the second elevation that is adjacent the fourth and fifth openings, and a second portion that is at the second elevation along only the second side of the connector module at the second elevation opposite the third openings and adjacent to the sixth openings.

The third plurality of connector openings can include one or more seventh openings that open on a first side of the connector module lateral to the longitudinal direction at a third elevation different from both the first and second elevations, and one or more eighth openings at the third elevation on the second side of the connector module. The neutral line sub bus can include a single portion at the third elevation that is adjacent the seventh and eighth openings.

The HOG component can include a controller and a data sub bus. The controller can be configured to operatively connect an external main data bus to the data sub bus. The data sub bus can include a feedback sensor operatively connected to the controller. The controller can be configured to: monitor feedback signals from the feedback sensor and/or from the plurality of branch devices, command the solid state switching component to open upon the receiving a signal through the main data bus and/or the data sub bus indicative of a fault in the line sub bus, determine which of the plurality of branch devices is connected to the fault, command any of the plurality of branch devices connected to the fault to open, and command the solid state switching component to close, allowing the plurality of branch devices other than any of the plurality of branch devices connected to the fault to resume service supplying power to their respective circuits.

A retrofitting method includes removing an old main switch and busses of an old electrical panel interior. The method includes installing a new relay switches and a new interior with main electrical buses, and installing a head of group (HOG) component in electrical communication with the main electrical busses.

The HOG component can be a first HOG component and the method can include installing a second HOG component in electrical communication with the main electrical busses. The method can include installing a plurality of electromechanical relays based branch devices onto the first and second HOG components. The method can include connecting each of the electromechanical relay based branch devices in the plurality of electromechanical relay based branch devices to a respective data sub bus of the first and second HOG components.

These and other features of the systems and methods of the subject disclosure will become more readily apparent to those skilled in the art from the following detailed description of the example embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, example embodiments thereof will be described in detail herein below with reference to certain figures, wherein:

FIG. 1 is a schematic view of an embodiment of a system constructed in accordance with the present disclosure, showing to head of group (HOG) components connected between the main busses of the interior and the branch devices;

FIG. 2 is a perspective view of the interior of the system of FIG. 1, showing the contacts for the HOG components to connect to the main busses;

FIG. 3 is a schematic perspective view of the interior of FIG. 2, showing the housing of the interior as transparent to show the main busses and the main isolators;

FIG. 4 is a perspective view of one of the HOG components of FIG. 1, showing the housing and openings in the housing for connecting branch devices to the sub busses;

FIG. 5 is a perspective view of the HOG component of FIG. 4, showing the connectors for connecting the HOG device to the main busses of the interior;

FIG. 6 is a schematic perspective view of the HOG component of FIG. 4, showing the sub busses with the housing removed;

FIG. 7 is a schematic perspective view of the HOG component of FIG. 4, showing the housing as transparent to show alignment of the openings with the sub busses;

FIG. 8 is a schematic front view of the HOG component of FIG. 4, showing the sections of the HOG component for one pole branch devices and for two pole branch devices;

FIG. 9 is a perspective view of a two pole branch device, showing the connectors of the branch device;

FIG. 10 is a perspective view of a one pole branch device, showing the connectors of the branch device;

FIG. 11 is a schematic view showing a method of retrofitting an electrical panel starting from a traditional electrical panel configuration and ending with the interior and HOG components of the system of FIG. 1;

FIG. 12 is an exploded schematic perspective view of a system as in FIG. 1, but with four HOG components; and

FIG. 13 is a schematic perspective view of the system of FIG. 12, showing branch devices populating the HOG components.

### DETAILED DESCRIPTION OF THE EXAMPLE EMBODIMENTS

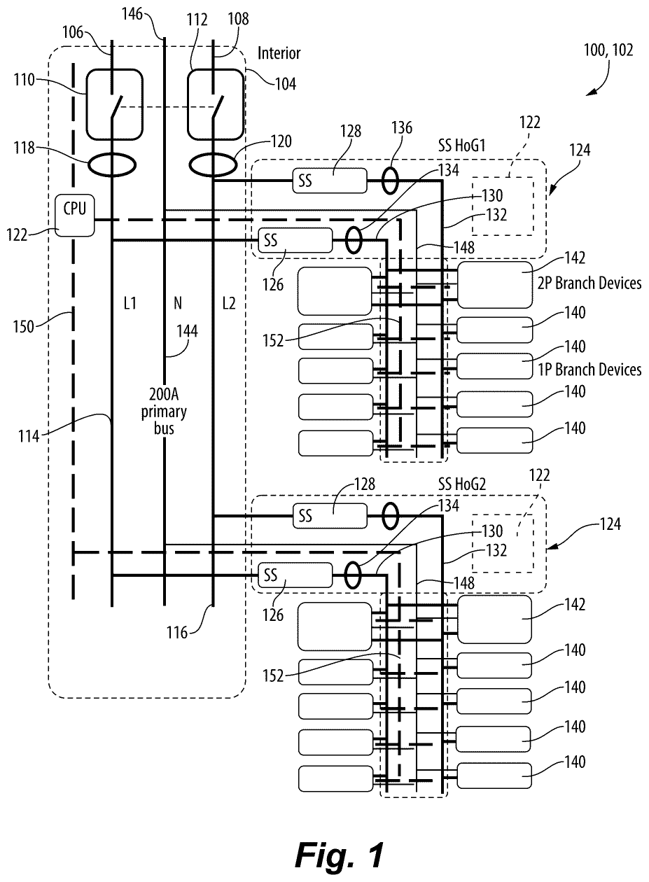

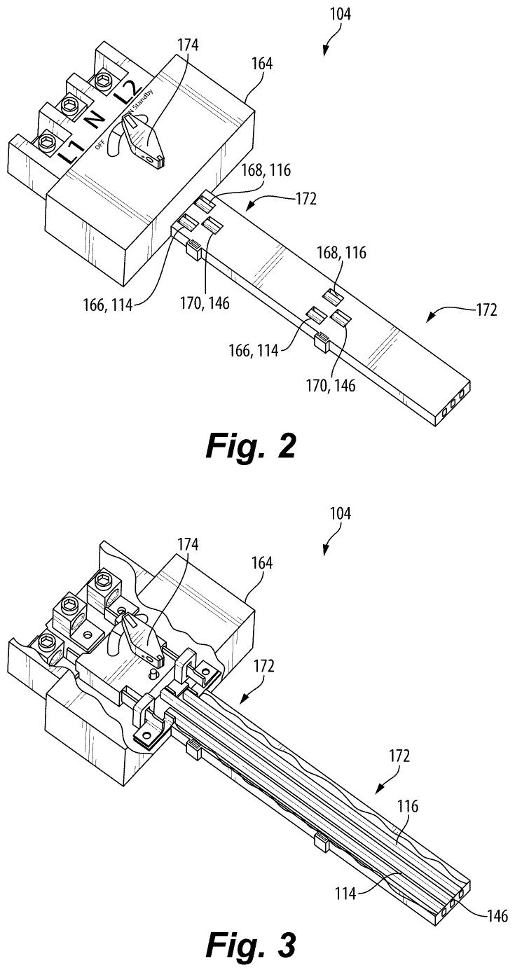

Reference will now be made to the drawings wherein like reference numerals identify similar structural features or aspects of the subject disclosure. For purposes of explanation and illustration, and not limitation, a partial view of an embodiment of a system in accordance with the disclosure is shown in FIG. 1 and is designated generally by reference character 100. Other embodiments of systems in accordance with the disclosure, or aspects thereof, are provided in FIGS. 2-13, as will be described. The systems and methods described herein can be used to for utilization of controllable switching devices in electrical panels such as for residential use, without the need to expose branch devices to high main line currents.

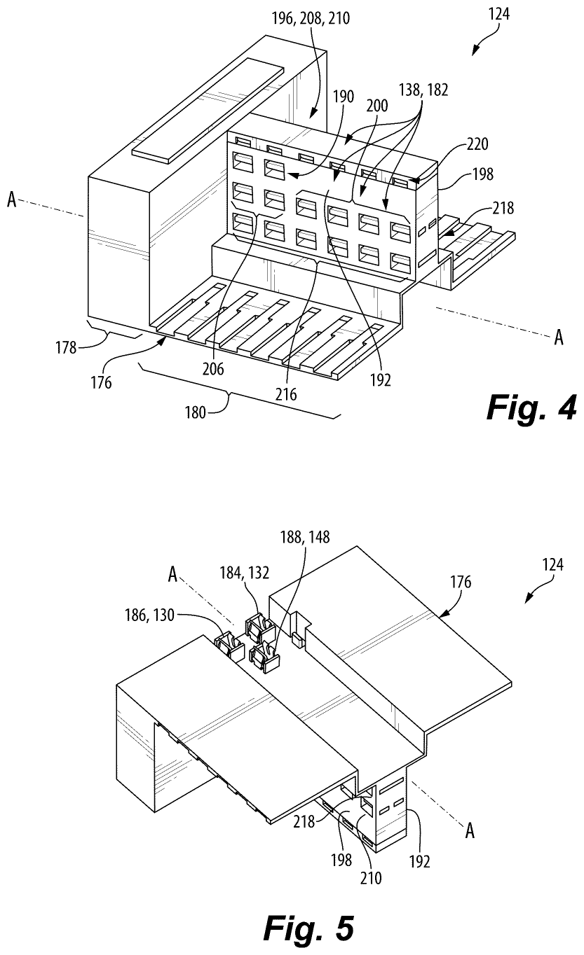

The system 100 includes an electrical panel 102 having an interior 104 including two lines in 106, 108, e.g. electrical lines passing into the electrical panel from outside the panel, each with a respective main isolator 110, 112 electrically connecting between the respective line-in 106, 108 and a main line bus 114, 116. Each main isolator 110, 112 has its own respective current sensor 118, 120 electrically connected to the controller 122 for feedback control of the main isolators 110, 112. Each main isolator 110, 112 can be a main relay and/or a main isolation switch and can include or be a traditional circuit breaker. A plurality of head of group (HOG) components 124 are electrically connected to each of the main line busses 114, 116. Each HOG component 124 includes a respective solid state switching component 126, 128 electrically connecting between each respective main line bus 114, 116 and a respective line sub bus 130, 132 of the HOG component 124. A respective current sensor 134, 136 is connected to each sub bus 130, 132 and to the controller 122 for feedback control of its respective solid state switching component 126,128. A plurality of circuit connectors 138 (not labeled in FIG. 1, but see FIG. 4) are electrically connected to the line sub busses 130, 132, for connecting a plurality of one pole branch devices 140 and/or two pole branch devices 142 electrically to at least some of the circuit connectors 138. The branch devices 140, 142 can be configured to fit a similar envelope and functionality to replace traditional miniature circuit breakers (MCBs).

The panel 102 includes a neutral main bus 144 in the interior 104, electrically connected to a main neutral line 146. Each of the HOG components 124 includes a neutral line sub bus 148 electrically connected to the neutral main bus 144 and a plurality of the circuit connectors 138 (labeled in FIG. 4) are electrically connected to the neutral line sub bus 148. The branch devices 140, 142 can each be electrically connected to at least some of the third plurality of circuit connectors 138 of the neutral sub bus 148.

The interior 104 includes a main data bus 150, e.g. a digital bus, with the controller 122, e.g. a central processing unit (CPU), microcontroller, or the like, operatively connected to the main data bus 150. Each HOG component 124 includes a data sub bus 152 that is operatively connected to the main data bus 150. The feedback sensors 134, 136 connect to the controller 122 through the data sub bus 152 and main data bus 150. The controller 122 is configured, e.g. with machine readable instructions, digital or analog logic, or the like, to provide fault protection of circuits, e.g. residential circuits, connected to the branch devices 140, 142. This includes monitoring feedback signals from the feedback sensors 136, 134 and or from the branch devices though the data buses 150, 152.

Those skilled in the art will readily appreciate that the art of tripping a branch device is more nuanced than one method. For High Current Faults (HCF, e.g., ˜>7× the branch device rating), both the HOG component 124 and branch device 140, 142 will detect. Both will open independently of each other in a race. The HOG component 124 can be ˜1000 times faster shutting off current, thereby protecting the faulting branch devices 140, 142 while it is opening. This will remove power to all the connected branch devices 140, 142, but only for a short time, then the HOG component 124 turns back ON resupplying power to all branch devices 140, 142.

For Ground Fault (GF), the branch device 140, 142 can detect this by itself, the HOG component 124 need not be configured to detect that low resolution (e.g., 6 milliamps). Only the branch device 140, 142 will open and clear ground fault level faults, typically in the 10s of amps for this type of interruption. The HOG component 124 can remain ON during this type of fault.

For Arc Fault (AF), the detection can come from both the HOG component 124 and the branch device 140, 142, but again only the branch device 140, 142 need open and clear the fault due to the low level, typically 10s of amps. The HOG component 124 can remain ON during this type of fault.

For Overload type faults, it depends on the severity. Both branch devices 140, 142 and the HOG component 124 can detect Overload type faults. If the current level is in the 1 to ˜3× the branch device rating, which is typical, only the branch device 140, 142 need open and clear the fault on its own. If the overload is more severe, such as 3 to 7× the branch device rating, then both the HOG component 124 and branch devices 140, 142 can open like a high current fault, with the HOG component then turning back ON.

For example, if the signals are indicative of a HCF fault, the controller 122 commands the affected one of the solid state switching components 126, 128 to open. The controller 122 determines which of the plurality of branch devices 140, 142 is connected to the fault. This can involve receiving a signal from the faulted branch device 140, 142 through the data sub bus 152 and main data bus 150. The faulted branch device 140, 142 can communicate its fault state through the data sub bus 152 and main data bus 150 to the controller 122. The controller 122 commands whichever of the solid state switching devices 126, 128 is connected to the faulted line-in the faulted branch device 140, 142 to open. This temporarily cuts off power to each of the branch devices 140, 142 connected to the HOG component 124 that is affected by the fault. Then the controller 122 commands the faulted branch device 140, 142 to open to a tripped state. The controller 122 can then command the open one of the solid state switching devices 126, 128 to close, reconnecting power to all of the branch devices 140, 142. At this point, power will be cut off only to the circuit connected to the faulted, tripped branch device 140, 142. Due to the speed of the solid state switching devices 126, 128, the brief interruption to the non-faulted circuits is negligible. This method of fault protection uses the solid state switching devices 126, 128 to limit the current in the HOG components 124, e.g. limiting to 150-200 A during high faults, to protect the branch devices 140, 142 from the full current in the main busses 114, 116, e.g. which could be 200 A, as well as to protect solid state components of the HOG component 124. Any time the sensors 134, 136 detect current above the HOG limit, e.g. 60 A, the associated solid state switching device 126, 128 opens to protect its branch devices 140, 142.

The controller 122 is in the interior 104 and operatively connects to the HOG components 124 through the main data bus 150. It is also contemplated that in addition to or in lieu of the controller 122 in the main data bus 150, a respective controller 122 can also be included in the HOG components 124 and can operatively connect to the main data bus 150 through the data sub bus 152, e.g. for input of control commands from an external person or device, and for output of data from the HOG component 124 to the external device or person. This can provide for communication of between the controller 122 and the branch devices 140, 142 for fault detection, open and close circuit commands, and the like. The controllers 122 in the HOG components 124 are indicated in broken lines in FIG. 1. Where there are more than one controller 122, the functions describe above for the controller 122 of the main data bus 150 can be distributed among the controllers 122.

As shown in FIGS. 9 and 10, each branch device 140, 142 includes a respective controllable electromechanical switch or electromechanical relay 154 electrically connected by respective connectors 158, 160, 162 between the line and neutral sub busses 130, 132, 148 (labeled in FIG. 1) and an output connector 156 for selectively supplying power to a respective circuit or suspending supply of power to the respective circuit depending on state of the electromechanical relay 154. Using relays in the branch devices provides potential advantages over solid state branch devices, such as cost per branch device, and watts loss (thermal performance) of each branch device. The HOG component 124 provides a current limiting island to protect the electromechanical relays 154 and prevent them from being exposed to the full current of the main busses 114, 116. Simple controllable electromechanical switches (e.g. relays) in the branch devices 140, 142 cannot always interrupt high current faults by themselves like a traditional circuit breaker, therefore, the HOG component 124 assists with its solid state switching devices 126, 128. The solid state switching devices 126, 128 can interrupt the current to all the branch devices 140, 142 connected to it extremely quickly, and then each branch device 140, 142 with the fault can open its contacts under a zero current state, eliminating the arcing and arc energy associated with high current interruption. Then once that branch is open, and the fault circuit or circuits are isolated from the electrical panel system 100, then the solid state switching device 126, 128 turns back ON allowing current to flow to all the branch devices 140, 142 connected thereto, and to the branch circuits where the branch devices 140, 142 are still in the ON state.

With reference now to FIG. 2, the interior 104 includes an electrically insulative enclosure 164 around the main isolators 110, 112 (and their sensors 118, 120 labeled in FIG. 1) and main line and neutral busses 114, 116, 144 labeled in FIG. 3. A respective contact opening 166, 168, 170 is provided through the enclosure 164 positioned proximate a respective one of the main busses 114, 116, 144, for electrical contact between the main and neutral line busses 114, 116, 146 and each of respective sub busses 130, 132, 148 of the respective HOG components 124 labeled in FIG. 1. There are two HOG stations 172 with the three contact openings 166, 168, 170 for accommodating two HOG components 124 as shown in FIG. 1, however as further discussed below any suitable number of HOG stations 172 can be included. The in addition to the electronic control of the main isolators 110, 112 described above with respect to FIG. 1, each relay include a mechanism for manual operation, e.g. by manipulation of the switch dial 174.

With reference now to FIG. 4, each HOG component 124 includes a HOG housing 176 that is electrically insulative. The HOG housing 176 includes a main switching module 178 that houses the first and second electromechanical relays 126, 128 therein, e.g. fully inside, embedded in a surface thereof, mounted to a surface thereof, or the like, and a connector module 180 extending along a longitudinal direction from the switching module along a longitudinal axis A. A plurality of openings 182 extend through the HOG housing 176 for connectors 138 to provide for electrical connection of the branch devices 140, 142 to the sub busses 130, 132, 148 as shown in FIG. 1. As shown in FIG. 5, each of the sub busses 130, 132, 148 has an opening and connector 184, 186, 188 passing therethrough configured for connecting the respective external bus 114, 116, 146 through the respective opening 166, 168, 170 (labeled in FIG. 2) in the housing 176 to the respective solid state switching component 126, 128 labeled in FIG. 1.

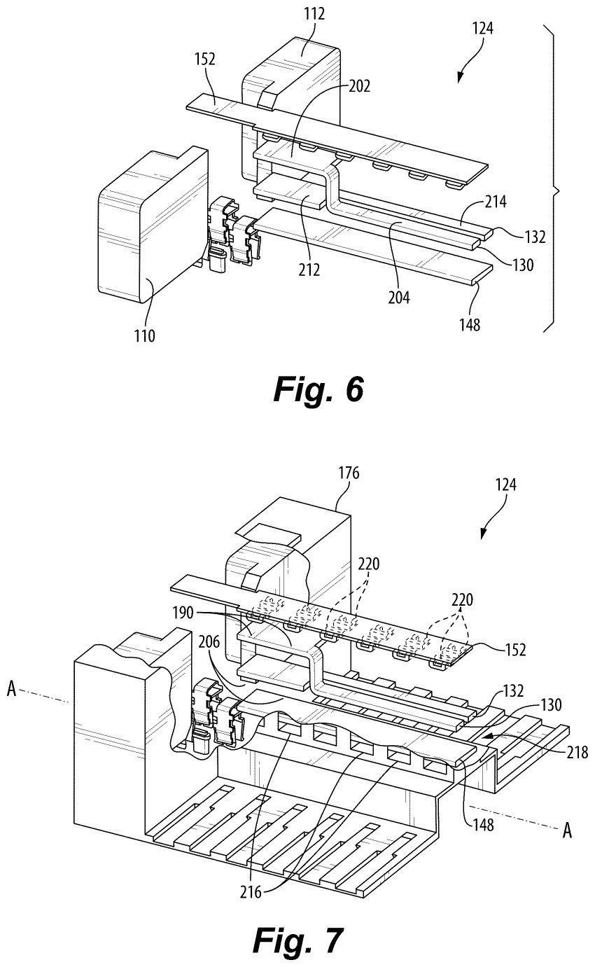

With reference again to FIG. 3, the first line sub bus 130, second line sub bus 132, and neutral line sub bus 148 all extend from the main switching module 178 and inside the connector module 180 in the longitudinal direction. The first plurality of connector openings includes one or more first openings 190 that open on a first side 192 of the connector module 180 lateral to the longitudinal direction at a first elevation relative to a base 194 of the housing 176. There are one or more second openings 196 (not visible in FIG. 4 but mirroring openings 190 at the same elevation as first openings 190 albeit on the second side 198 of the connector module 180) and one or more third openings 200 on the first side 192 of the connector module 180 at a second elevation off set from the first elevation. As shown in FIG. 6 with the housing 176 of FIG. 3 removed, the first line sub bus 130 includes a first portion 202 at the first elevation that is adjacent the first and second openings 190, 196 (labeled in FIG. 3) on both sides 192, 198 of the connector module 180, and a second portion 204 that is at the second elevation, and is along only the first side 192 of the connector module 180 at the second elevation adjacent to the third openings 200 labeled in FIG. 3.

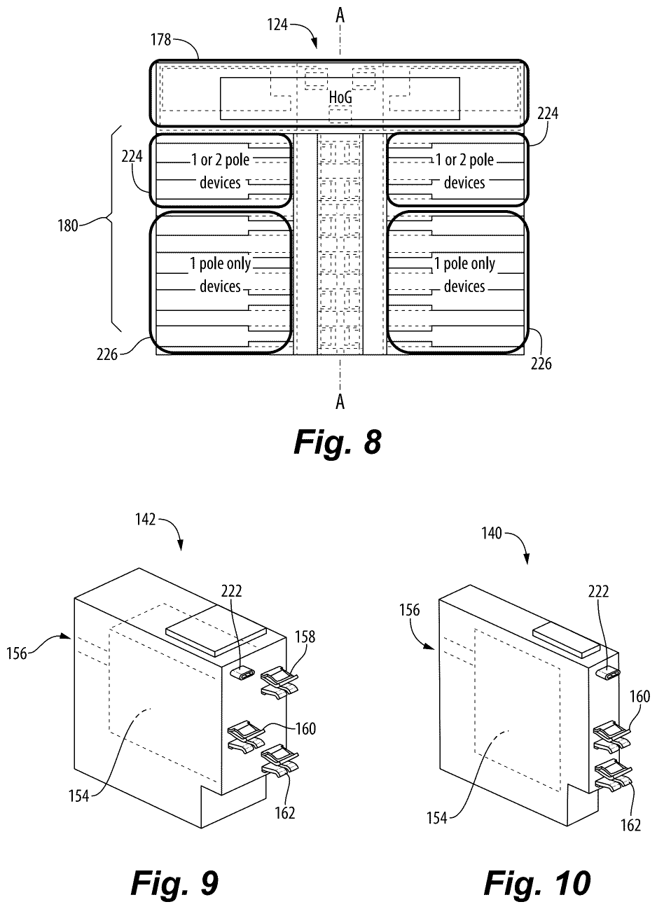

With continued reference to FIG. 3, One or more fourth openings 206 open on the first side 192 of the connector module 180 lateral to the longitudinal direction at the second elevation with the openings 200. One or more fifth openings 208 open at the second elevation on the second side 198 (not visible in FIG. 4 but mirroring the openings 206) of the connector module 180 adjacent to the second openings 196. One or more sixth openings 210 (not shown in FIG. 4, but mirroring openings 200 and see FIG. 5) open at the second elevation on the second side 198 of the connector module 180 offset along the longitudinal axis A from the second openings 196. As shown in FIG. 6, the second line sub bus 132 includes a first portion 212 at the second elevation that is adjacent the fourth and fifth openings 206, 208 (labeled in FIG. 3), and a second portion 214 that is at the second elevation and along only the second side 198 of the connector module 180 at the second elevation opposite the third openings 200 and adjacent to the sixth openings 210 (labeled in FIGS. 3-4). This arrangement in the sub busses 130, 132 allows for loading both sides 192, 198 of the connector module 180 with single pole branch devices 140 such as those shown in FIG. 10, and helps balance electrical loading between the first and second line sub busses 130, 132 for the single pole branch devices 140. It also makes it so there need only be one configuration the single pole branch devices 140, i.e. with a line connector 160 at the second elevation for openings 200, 210 of FIGS. 3-4. The double sided portions 202, 212 of the sub busses 130, 132 provide one or more slots 224, labeled in FIG. 8, for two pole branch devices 142 of FIG. 9 on each side of the connector module 180 with connectors 158 at the first elevation for the openings 190, 196. The second connectors 160 of the two pole branch devices 142 are at the elevation for connecting through the openings 206, 208 of FIG. 3. The rest of the slots 226 labeled in FIG. 8 on connector module 180 are configured for one pole branch devices 140 of FIG. 10.

For the neutral connections, one or more seventh openings 216 open on the first side 192 of the connector module 180 lateral to the longitudinal direction at a third elevation different from both the first and second elevations. One or more eighth openings 218 open at the third elevation on the second side 198 of the connector module 180, not shown in FIG. 3, but mirroring the openings 216 and see FIG. 4. As shown in FIG. 6, the neutral line sub bus 148 includes a single portion at the third elevation that is adjacent the seventh and eighth openings 216, 218 of FIGS. 3-4. There are also openings 220 on either side 192, 198 of the connector module 180 for connecting data connectors 222 of the branch devices 140, 142 of FIGS. 9-10 to the data sub bus 152. FIG. 7 shows the housing 176 transparent, showing the elevation alignment of the sub busses 130, 132, 148, 152 with the openings 190, 200, 206, 210, 216, 218, 220 of FIGS. 4-5.

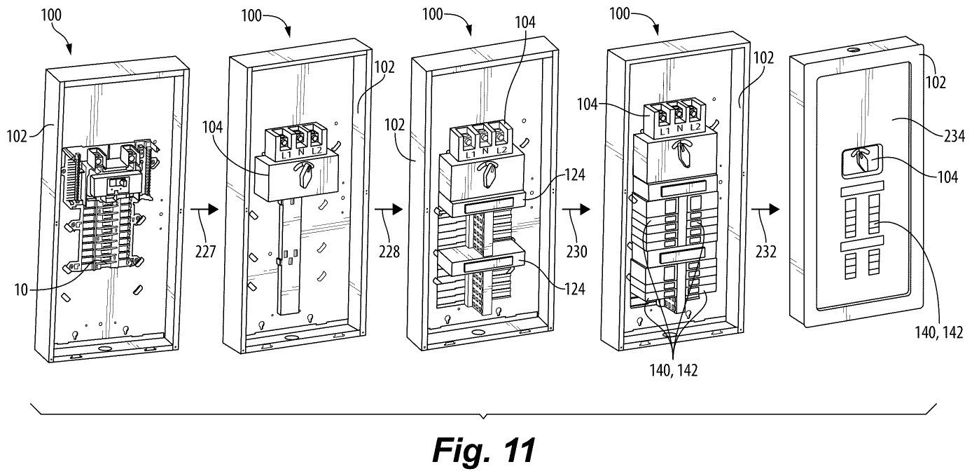

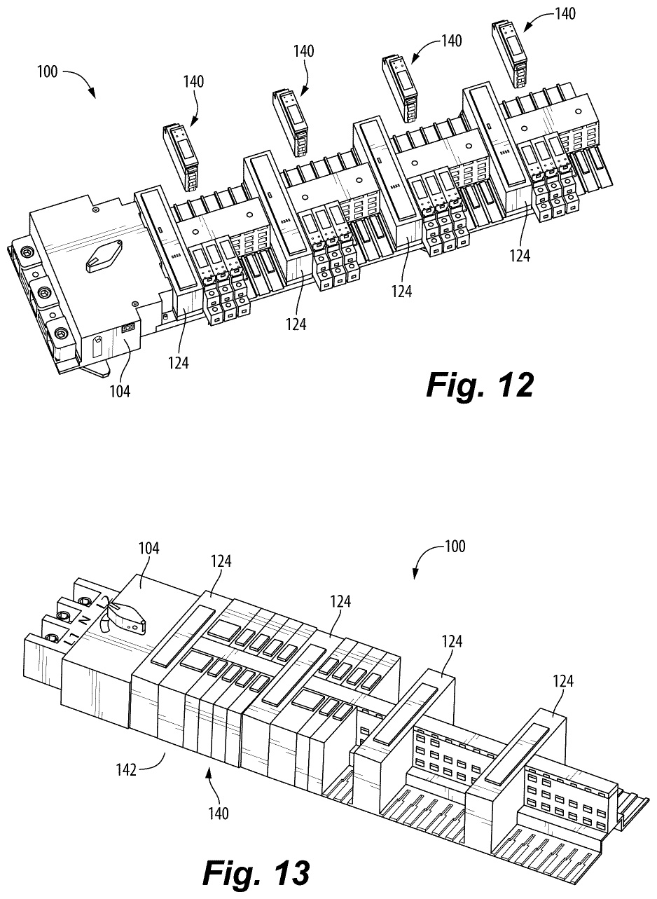

With reference now to FIG. 11, a retrofitting method is shown. The method includes removing an old main switch and busses of an old electrical panel interior 10 and installing a new main isolator switches 110, 112 (labeled in FIG. 1) and a new interior 104 with main electrical buses 114, 116, 144 and a main data bus 150 (labeled in FIG. 1), as indicated by the arrow 227. As indicated by the arrow 228, the method includes installing HOG components 124 to the interior 104 in electrical communication with the main electrical busses main electrical buses 114, 116, 144 (labeled in FIG. 1). The arrows 230 indicate that the method includes installing a plurality of electromechanical relay based branch devices 140, 142 onto the first and second HOG components 124. The method includes connecting each of the electromechanical relay based branch devices 140, 142 to a respective data sub bus 152 (labeled in FIG. 1) of the first and second HOG components 124. Although this example shows only two HOG components 124, FIGS. 12 and 13 show installing branch devices 140, 142 into a similar system 100 with capacity for four HOG components 124. Those skilled in the art will readily appreciate that any suitable number of HOG components 124 can be included in a system without departing from the scope of this disclosure. Arrow 232 indicates that a cover 234 can be added to enclose the interior 104 within the panel 102.

Systems and methods as disclosed herein can provide potential benefits including the following. The main isolators 110, 112 are island relays, and can disconnect the busses 114, 116 from a utility. They can be rated, e.g., for 200 A or any other suitable current. The HOG components 124 are modular and each provides sub busses for twelve branch devices 140, 142, although those skilled in the art will readily appreciation that any other suitable number of branch devices can be accommodated modified configurations within the scope of this disclosure. The HOG components can limit current in their respective sub busses to, e.g., 60 A or any other suitable current limit. The branch devices 140, 142 are plug on branch devices, and can incorporate ELM (Earth leakage module) switches. Systems as disclosed herein can be retrofit into existing load centers, using a new interior 104 and cover 234. Having multiple HOG components 124 means smaller, less expensive controllable switching devices, e.g. electromechanical relays, can be used at the branch level. In addition, no one HOG component 124 failing takes out the whole system. Bandwidth jams are also reduced in the sub data bus architecture disclosed herein.

The methods and systems of the present disclosure, as described above and shown in the drawings, provide for utilization of controllable switching devices in electrical panels such as for residential use, without the need to expose branch devices to high main line currents. While the apparatus and methods of the subject disclosure have been shown and described with reference to example embodiments, those skilled in the art will readily appreciate that changes and/or modifications may be made thereto without departing from the scope of the subject disclosure.

What is claimed is:

1. A system comprising:
an electrical panel having an interior including a line-in with a main isolator electrically connecting between the line-in and a main line bus;
a head of group (HOG) component electrically connected to the main line bus, the HOG component including:
a solid state switching component electrically connecting between the main line bus and a line sub bus of the HOG component;
a plurality of circuit connectors electrically connected to the line sub bus of the HOG component; and
a plurality of branch devices electrically connected to at least some of the circuit connectors.

2. The system as recited in claim 1, wherein the line-in is a first line-in, wherein the main isolator is a first main isolator, wherein the main line bus is a first main line bus, wherein the solid state switching component is a first solid state switching component, wherein the line sub bus is a first line sub bus, wherein the plurality of circuit connectors is a first plurality of circuit connectors, and wherein the panel includes:
a second line-in with a second main isolator electrically connecting between the second line-in and a second main line bus, wherein the HOG component is electrically connected to the second main line bus, the HOG component including:
a second solid state switching component electrically connecting between the second main line bus and a second line sub bus of the HOG component; and
a second plurality of circuit connectors electrically connected to the second line sub bus of the first HOG, wherein the plurality of branch devices are electrically connected to at least some of the second plurality of circuit connectors.

3. The system as recited in claim 2, wherein the panel includes a neutral main bus, wherein the HOG component includes:
a neutral line sub bus electrically connected to the neutral main bus; and
a third plurality of circuit connectors electrically connected to the neutral line sub bus, wherein the plurality of branch devices are electrically connected to at least some of the third plurality of circuit connectors.

4. The system as recited in claim 1, wherein the interior includes a main data bus with controller operatively connected to the main data bus, wherein the HOG component includes a data sub bus, and wherein the data sub bus is operatively connected to the main data bus and includes a feedback sensor, wherein the controller is configured to:
monitor feedback signals from the feedback sensor and/or from the plurality of branch devices;
command the solid state switching component to open upon the receiving a signal through the main data bus and/or the data sub bus indicative of a fault in the line sub bus;
command any of the plurality of branch devices connected to the fault to open; and
command the solid state switching component to close, allowing ones of the plurality of branch devices other than any of the plurality of branch devices connected to the fault to resume service supplying power to their respective circuits.

5. The system as recited in claim 4, wherein the controller is in the interior and operatively connects to the HOG component through the main data bus.

6. The system as recited in claim 5, wherein the controller is in the HOG component and operatively connects to the main data bus and to the data sub bus.

7. The system as recited in claim 1, wherein the HOG component is one in a plurality of HOG components, each electrically connected to the main line bus, and each including respectively:
a solid state switching component electrically connecting between the main line bus and a line sub bus of the HOG component;
a plurality of circuit connectors electrically connected to the line sub bus of the HOG component; and
a plurality of branch devices electrically respectively connected to at least some of the circuit connectors.

8. The system as recited in claim 7, wherein each respective HOG component in the plurality of HOG components includes a respective controller in the respective HOG component operatively connected to the main data bus.

9. The system as recited in claim 1, wherein each branch device in the plurality of branch devices includes a respective electromechanical relay electrically connected between the line sub bus and an output connector for selectively supplying power to a respective circuit or suspending supply of power to the respective circuit depending on state of the electromechanical relay, wherein the system includes one or more controllers operatively connected to control state of each respective electromechanical relay.

10. The system as recited in claim 1, wherein the interior includes an electrically insulative enclosure around the main isolator and main line bus, with a respective contact opening therethrough for electrical contact between the main line bus and each of one or more respective HOG components.

11. The system as recited in claim 1, wherein the main isolator includes a mechanism for both manual operation and automatic operation by a controller.

12. A head of group (HOG) component comprising:
a HOG housing that is electrically insulative;
a solid state switching component in the HOG housing, wherein at least one opening through the HOG housing provides for electrical connection of a main line bus external of the HOG housing, through the HOG housing, and to the solid state switching component;
a line sub bus in the HOG housing, wherein the solid state switching component is configured to electrically connect between the main line bus and the line sub bus; and
a plurality of circuit connectors electrically connected to the line sub bus of the HOG component for electrical connection of a plurality of branch devices to the line sub bus.

13. The HOG component as recited in claim 12, wherein the solid state switching component is a first solid state switching component, wherein the line sub bus is a first line sub bus, and further comprising:
a second solid state switching component in the HOG housing, wherein at least one opening through the HOG housing provides for connection of a second main line bus external of the HOG housing, through the HOG housing, and to the solid state switching component;
a second line sub bus in the HOG housing, wherein the second solid state switching component is configured to electrically connect between to the second main line bus the second line sub bus; and
a second plurality of circuit connectors electrically connected to the second line sub bus for electrical connection of a plurality of branch devices to the second line sub bus.

14. The HOG component as recited in claim 13, further comprising:
a neutral line sub bus in the HOG housing, configured to be electrically connected to an external neutral main bus; and
a third plurality of circuit connectors electrically connected to the neutral line sub bus, for electrical connection of at least some of the plurality of branch devices to the neutral line sub bus.

15. The HOG component as recited in claim 14, wherein the HOG housing includes a main switching module, and a connector module extending along a longitudinal direction from the switching module along a longitudinal axis, wherein the first line sub bus, second line sub bus, and neutral line sub bus all extend from the main switching module and inside the connector module in the longitudinal direction, wherein the first plurality of connector openings includes:
one or more first openings that open on a first side of the connector module lateral to the longitudinal direction at a first elevation,
one or more second openings at the first elevation on a second side of the connector module, and
one or more third openings on the first side of the connector module at a second elevation off set from the first elevation, wherein the first line sub bus includes a first portion at the first elevation that is adjacent the first and second openings, and a second portion that is at the second elevation along only the first side of the connector module at the second elevation adjacent to the third openings;
wherein the second plurality of connector openings includes:
one or more fourth openings that open on the first side of the connector module lateral to the longitudinal direction at the second elevation,
one or more fifth openings at the second elevation on the second side of the connector module adjacent to the second openings, and
one or more sixth openings at the second elevation on the second side of the connector module offset from the second openings, wherein the second line sub bus includes a first portion at the second elevation that is adjacent the fourth and fifth openings, and a second portion that is at the second elevation along only the second side of the connector module at the second elevation opposite the third openings and adjacent to the sixth openings;
wherein the third plurality of connector openings includes:
one or more seventh openings that open on a first side of the connector module lateral to the longitudinal direction at a third elevation different from both the first and second elevations, and
one or more eighth openings at the third elevation on the second side of the connector module, wherein the neutral line sub bus includes a single portion at the third elevation that is adjacent the seventh and eighth openings.

16. The HOG component as recited in claim 12, further comprising:
a controller;
a data sub bus, wherein the controller is configured to operatively connect an external main data bus to the data sub bus, wherein the data sub bus includes a feedback sensor operatively connected to the controller, wherein the controller is configured to:
monitor feedback signals from the feedback sensor and/or from the plurality of branch devices;
command the solid state switching component to open upon the receiving a signal through the main data bus and/or the data sub bus indicative of a fault in the line sub bus;
command any of the plurality of branch devices connected to the fault to open; and
command the solid state switching component to close, allowing the plurality of branch devices other than any of the plurality of branch devices connected to the fault to resume service supplying power to their respective circuits.

17. A retrofitting method comprising:
removing an old main switch and busses of an old electrical panel interior;
installing a new relay switch and a new interior with main electrical buses; and
installing a head of group (HOG) component in electrical communication with the main electrical busses.

18. The method as recited in claim 19, wherein the HOG component is a first HOG component and further comprising installing a second HOG component in electrical communication with the main electrical busses.

19. The method as recited in claim 18, further comprising installing a plurality of electromechanical relay based branch devices onto the first and second HOG components.

20. The method as recited in claim 19, further comprising connecting each of the electromechanical relay based branch devices in the plurality of electromechanical relay based branch devices to a respective data sub bus of the first and second HOG components.
